(19) United States
(12) Patent Application Publication
(10) Pub. No.: US 2015/0041570 A1
(43) Pub. Date: Feb. 12, 2015

(54) NOZZLE TIP

(71) Applicant: Samsung Electro-Mechanics Co., Ltd., Suwon (KR)

(72) Inventors: Min Chul GO, Suwon (KR); Chun Mo Sung, Yongin (KR)

(73) Assignee: Samsung Electro-Mechanics Co., Ltd., Suwon (KR)

(21) Appl. No.: 14/206,270

(22) Filed: Mar. 12, 2014

(30) Foreign Application Priority Data
Aug. 12, 2013 (KR) 10-2013-0095412

(51) Int. Cl. B05B 1/02

(52) U.S. Cl. CPC B05B 1/02
USPC 239/597

(57) ABSTRACT

Disclosed herein is a nozzle tip coupled to a nozzle header so that washing water is sprayed toward a substrate during a process of washing the substrate, the nozzle tip including: a flange having a hollow part formed therein; and a pipe body having a discharging slit formed in a front end portion thereof so as to be communicated with the hollow part of the flange.

### CROSS REFERENCE(S) TO RELATED APPLICATIONS

This application claims the foreign priority benefit under 35 U.S.C. Section 119 of Korean Patent Application Serial No. 10-2013-0095412, entitled “Nozzle Tip” filed on Aug. 12, 2013, which is hereby incorporated by reference in its entirety into this application.

### BACKGROUND OF THE INVENTION

1. Technical Field

The present invention relates to a nozzle tip, and more particularly, to a nozzle tip spraying washing water toward a surface of a substrate during a process of washing the substrate.

2. Description of the Related Art

In general, for processes of washing and etching a substrate, a variety of foreign materials smeared on a surface of the substrate are removed by mist sprayed with a two-fluid nozzle.

That is, water and air is introduced into the two-fluid nozzle and is then atomized, such that the two-fluid nozzle sprays the mist which is a mixture of the atomized water and air toward the surface of the substrate at a predetermined angle.

The above-mentioned two-fluid nozzle according to the related art generally performs a cleaning of the substrate by making a spray angle of the mist wide, and is used by making a spray thickness thin to thereby increase striking power.

The spray angle of the two-fluid nozzle is adjusted depending on a thickness or a position of a spray angle adjusting member formed in a ring shape.

In the case in which the spray angle needs to be adjusted during the spray of the mist, however, the two-fluid nozzle according to the related art is inconvenient in that in order to use it, it first needs to separate the spray angle adjusting member therefrom and then inserting another spray angle adjusting member thereinto.

Particularly, during a process of replacing the spray angle adjusting member, after the spray angle adjusting member is forcedly separated from the two-fluid nozzle, it may be replaced, such that workability may be decreased.

In addition, since the two-fluid nozzle has a large number of components, it also has a large number of assemblies and processes, and in a case of an internal structure thereof, a straight fluid path portion and a streamlined fluid path portion in a fluid path thereof are connected to each other, such that processability may be significantly degraded.

### RELATED ART DOCUMENT

### Patent Document

(Patent Document 1) Cited Reference: Korean Patent Laid-Open Publication No. 2005-0102966

### SUMMARY OF THE INVENTION

An object of the present invention is to provide a nozzle tip having excellent processability and assembly property by a reduced number of components.

Another object of the present invention is to provide a nozzle tip improving fluidity of a fluid by configuring a fluid path of the fluid as a streamlined shape.

According to an exemplary embodiment of the present invention, there is provided a nozzle tip coupled to a nozzle header so that washing water is sprayed toward a substrate during a process of washing the substrate, the nozzle tip including: a flange having a hollow part formed therein; and a pipe body having a discharging slit formed in a front end portion thereof so as to be communicated with the hollow part of the flange.

The nozzle header and the flange may be provided with an alignment protrusion and an alignment hole, respectively, at least one alignment protrusion may be formed on the nozzle header, and the alignment hole may be formed so as to correspond to a number and position of the alignment protrusion of the nozzle header.

The pipe body may have a fluid path guide formed on an inner surface thereof so that the washing water introduced through the hollow part is moved to the center of the discharging slit.

The fluid path guide may be formed in a streamlined shape toward a position at which the discharging slit of the pipe body is formed.

The discharging slit of the pipe body may have a communication hole formed in a central portion thereof so that the washing water introduced is discharged.

The fluid path guide may have an end portion connected up to a position exceeding a half of a depth of the discharging slit and the discharging slit may determine a spray angle of the washing water depending on a width and a length thereof.

The flange may be fixed to the nozzle header having a screw thread formed on a circumferential surface thereof by a nut.

### BRIEF DESCRIPTION OF THE DRAWINGS

FIG. 1 is a perspective view showing a nozzle tip according to an exemplary embodiment of the present invention;

FIG. 2 is a cross-sectional view of the nozzle tip according to the exemplary embodiment of the present invention;

FIGS. 3A and 3B are illustration views showing a spray angle of the nozzle tip according to the exemplary embodiment of the present invention;

FIG. 4 is an illustration view showing a state in which the nozzle tip according to the exemplary embodiment of the present invention is installed; and

FIG. 5 is an illustration view showing an actuating state of the nozzle tip according to the exemplary embodiment of the present invention.

### DESCRIPTION OF THE PREFERRED EMBODIMENTS

Hereinafter, an exemplary embodiment of the present invention will be described in detail with reference to the accompanying drawings.

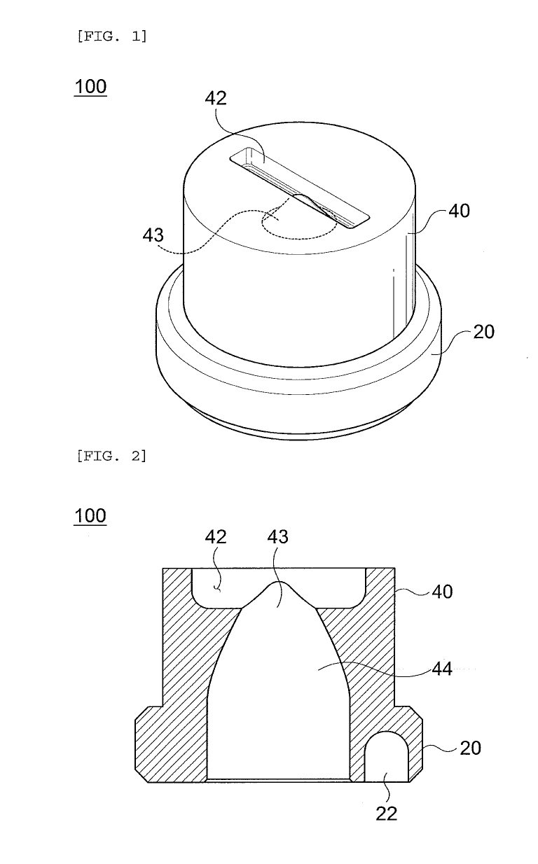

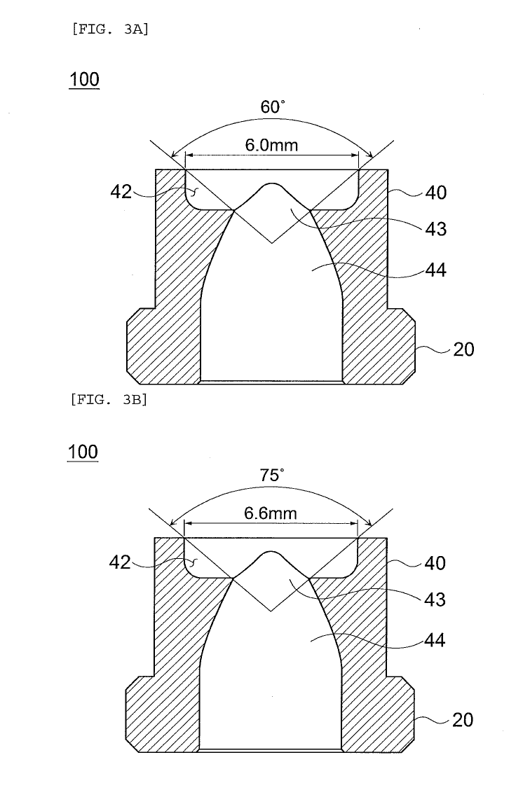

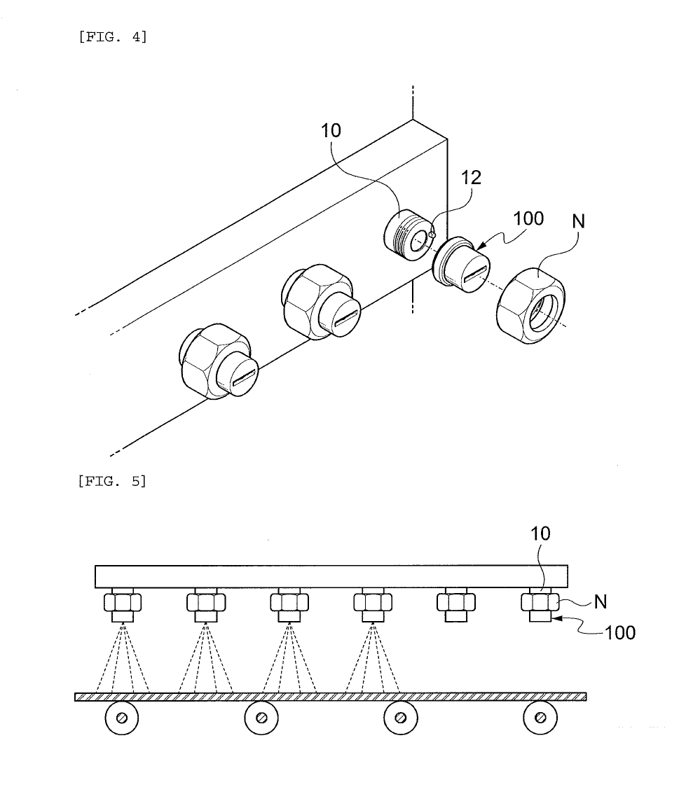

FIG. 1 is a perspective view showing a nozzle tip according to an exemplary embodiment of the present invention, FIG. 2 is a cross-sectional view of the nozzle tip according to the exemplary embodiment of the present invention, FIGS. 3A and 3B are illustration views showing a spray angle of the nozzle tip according to the exemplary embodiment of the present invention, FIG. 4 is an illustration view showing a state in which the nozzle tip according to the exemplary embodiment of the present invention is installed, and FIG. 5 is an illustration view showing an actuating state of the nozzle tip according to the exemplary embodiment of the present invention.

As shown in FIGS. 1 to 4, the nozzle tip 100 according to the exemplary embodiment of the present invention removes foreign materials smeared on a surface of a substrate by spraying washing water toward the substrate during a process of washing the substrate.

The nozzle tips 100 are each coupled to nozzle headers 10 disposed to be spaced apart from each other by a predetermined interval and are disposed so that a spray angle thereof does not intersect with an adjacent nozzle header 10.

The nozzle tip 100 according to the exemplary embodiment of the present invention includes a flange 20 closely attached to a front end surface of the nozzle header 10 and having a hollow part formed in a central portion thereof, and a pipe body 40 having a discharging slit 42 formed in the a front end portion so as to be communicated with the hollow part of the flange 20.

The flange 20 may be configured to have the same diameter as that of the nozzle header 10. In this case, the nozzle header 10 has an alignment protrusion 12 formed on the front end surface thereof. In contrast, the flange 20 is provided with an alignment hole 22 into which the alignment protrusion 12 of the nozzle header is inserted.

That is, the flange 20 and the nozzle header 10 may be each provided with at least one alignment hole 22 and alignment protrusion 12 and may be provided with two or more alignment holes 22 and alignment protrusions 12 in some cases, to thereby be inserted into each other.

In addition, the flange 20 has the pipe body having a cylindrical shape configured integrally therewith. The pipe body 40 is communicated with the hollow part of the flange 20, and has one surface which is opened and an opposite surface which is blocked except for the discharging slit 42 formed in the central portion thereof.

That is, the pipe body 40 has a cup shape in which one surface is opened, and has the discharging slit 42 for introducing and discharging washing water, formed in the central portion thereof.

The discharging slit 42 has a communication hole 43 punched therein so as to be communicated with an inner portion of the pipe body 40. The above-mentioned discharging slit 42 may be formed so as to have a groove shape having a predetermined depth.

In addition, the spray angle of the washing water may be determined by a width and a length of the discharging slit 42. That is, as the width and the length of the discharging slit 42 become long, the spray angle of the washing water becomes large. In contrast, as the width and the length of the discharging slit 42 become small, the spray angle becomes narrow.

Therefore, when the discharging slit 42 is formed in the pipe body 40, an angle to be sprayed is calculated in advance, and then the discharging slit 42 needs to be formed depending on the calculated angle.

Meanwhile, the pipe body 40 may have a fluid path guide 44 formed on an inner surface thereof so that the washing water introduced through the hollow part is moved to the central portion of the discharging slit 42.

The fluid path guide 44 has a shape in which an internal diameter thereof becomes narrow in a streamlined shape at a connection part of the flange 20 and the pipe body 40.

A front end portion of the fluid path guide 44 formed in the streamlined shape may be formed up to a position passing through the communication hole 43 of the discharging slit and partially exceeding a half of a depth of the discharging slit 42. This is to allow the washing water to be smoothly moved to the communication hole 43 through the fluid path guide 44.

As described above, as shown in FIG. 5, the nozzle tip according to the exemplary embodiment of the present invention is integrated by closely attaching the flange 20 to the plurality of nozzle headers 10 disposed at a predetermined interval so that the alignment protrusion 12 is inserted into the alignment hole 22, and then fastening a nut N.

Of course, the nozzle head 10 has a screw thread formed on a circumferential surface thereof, such that the nozzle header 10 and the nozzle tip 100 are fixed to each other by the nut N when the nozzle tip 100 is closely attached to the nozzle header 10 and the nut N is then tightened.

Once the nozzle tip 100 is fixed as described above, the washing water is supplied to the nozzle header 10.

The washing water supplied to the nozzle header 10 passes through the nozzle header 10 and is moved to the hollow part of the pipe body 40.

The washing water introduced into the pipe body 40 moves along the fluid path guide 44 and is sprayed to an intersected direction from an end portion of the communication hole 43 of the discharging slit 42.

In this case, assuming that the length of the discharging slit 42 is 6 mm, for example, the spray angle is approximately 60°, and if the discharging slit 42 is formed to have the length of 6.6 mm, the spray angle is approximately 75°.

That is, as the width and the length of the discharging slit 42 are large, the spray angle of the washing water has an expanded spray angle. In contrast, as the width and the length of the discharging slit are small, the spray angle has a narrow spray angle.

As such, the nozzle tip 100 according to the exemplary embodiment of the present invention may maintain an installed state as it is when the nut N is not separated from the screw thread of the nozzle head 10 in a state in which it is installed in the nozzle header 10, and the nozzle tip 100 may be conveniently replaced when the nut N is loosened in order to replace and install the nozzle tip 100.

In addition, in the case of the nozzle tip 100 according to the exemplary embodiment of the present invention, the washing water may be sprayed by a single component without assembling a plurality of components, such that it may be expected that the manufacturing process is simplified and cost is decreased.

According to the exemplary embodiment of the present invention, the nozzle tip may have excellent processability and assembly property by the reduced number of components to thereby significantly decrease manufacturing cost and may configure the fluid path of the fluid as the streamlined shape to thereby improve fluidity of the fluid.

Although the nozzle tip according to the exemplary embodiment of the present invention has been described, the present invention is not limited thereto, but those skilled in the art will appreciate that various applications and modifications are possible.

1. A nozzle tip coupled to a nozzle header so that washing water is sprayed toward a substrate during a process of washing the substrate, the nozzle tip comprising:
a flange having a hollow part formed therein; and
a pipe body having a discharging slit formed in a front end portion thereof so as to be communicated with the hollow part of the flange.

2. The nozzle tip according to claim 1, wherein the nozzle header and the flange are provided with an alignment protrusion and an alignment hole, respectively.

3. The nozzle tip according to claim 2, wherein at least one alignment protrusion is formed on the nozzle header.

4. The nozzle tip according to claim 2, wherein the alignment hole is formed so as to correspond to a number and position of the alignment protrusion of the nozzle header.

5. The nozzle tip according to claim 1, wherein the pipe body has a fluid path guide formed on an inner surface thereof so that the washing water introduced through the hollow part is moved to the center of the discharging slit.

6. The nozzle tip according to claim 5, wherein the fluid path guide is formed in a streamlined shape toward a position at which the discharging slit of the pipe body is formed.

7. The nozzle tip according to claim 1, wherein the discharging slit of the pipe body has a communication hole formed in a central portion thereof so that the washing water introduced is discharged.

8. The nozzle tip according to claim 1, wherein the fluid path guide has an end portion connected up to a position exceeding a half of a depth of the discharging slit.

9. The nozzle tip according to claim 1, wherein the discharging slit determines a spray angle of the washing water depending on a width and a length thereof.

10. The nozzle tip according to claim 1, wherein the flange is fixed to the nozzle header having a screw thread formed on a circumferential surface thereof by a nut.

11. The nozzle tip according to claim 3, wherein the alignment hole is formed so as to correspond to a number and position of the alignment protrusion of the nozzle header.

12. The nozzle tip according to claim 5, wherein the fluid path guide has an end portion connected up to a position exceeding a half of a depth of the discharging slit.
